(19) United States
(12) Patent Application Publication
(10) Pub. No.: US 2026/0105194 A1
(43) Pub. Date: Apr. 16, 2026

(54) GENERATION AND VALIDATION SYSTEM FOR HARDWARE CONFIGURATIONS

(71) Applicant: QUALCOMM Incorporated, San Diego, CA (US)

(72) Inventor: Denis POCHUEV, Orinda, CA (US)

(21) Appl. No.: 18/915,200

(22) Filed: Oct. 14, 2024

(51) Int. Cl. G06F 21/70

(52) U.S. Cl. CPC G06F 21/70

(57) ABSTRACT

Disclosed are systems, apparatuses, processes, and computer-readable media for payload processing (e.g., license validation system for hardware configurations). According to at least one example, a method for configuring an apparatus based on a license payload includes: receiving the license payload for configuring a plurality of hardware components of the apparatus operating in a first configuration to operate in a second configuration, wherein the license payload includes an indicator of a history binding that binds the license payload to follow the first configuration; and determining the received license payload is valid for application of the second configuration to the apparatus based on the history binding.

### FIELD

The present disclosure generally relates to configuring hardware and software of devices. For example, aspects of the present disclosure are related to a generation and license validation system for hardware configurations.

### BACKGROUND

A System on Chip (SoC) integrates various components such as a central processor unit (CPU), a graphics processor unit (GPU), memory, and peripheral interfaces onto a single chip, offering a compact and efficient solution for powering devices like smartphones, tablets, and embedded systems. SoCs can come in different SKUs (Stock Keeping Units), which represent different versions or revisions of the same SoC with slight variations. These revisions may introduce improvements in performance, power consumption, or specific features by adjusting elements like CPU core count, clock speeds, adding new components, and so forth. In some cases, the revisions may also be predicated based on process changes in the semiconductor fabrication process. Manufacturers can refine the SoC over time and address diverse market needs without overhauling the entire design by offering different revisions of the same SoC.

### SUMMARY

In some examples, systems and techniques are described for generation and validation system for hardware configurations. According to at least one example, a method for payload processing is provided. The method includes: receiving a license payload for configuring a plurality of hardware components of an apparatus operating in a first configuration to operate in a second configuration, wherein the license payload includes an indicator of a history binding that binds the license payload to follow the first configuration; and determining the received license payload is valid for application of the second configuration to the apparatus based on the history binding.

In another example, an apparatus for payload processing is provided. The apparatus includes at least one memory and at least one processor (e.g., configured in circuitry) coupled to the at least one memory and configured to: receive a license payload for configuring a plurality of hardware components of the apparatus operating in a first configuration to operate in a second configuration, wherein the license payload includes an indicator of a history binding that binds the license payload to follow the first configuration; and determine the received license payload is valid for application of the second configuration to the apparatus based on the history binding.

In another example, a non-transitory computer-readable medium of an apparatus is provided that has stored thereon instructions that, when executed by one or more processors, cause the one or more processors to: receive a license payload for configuring a plurality of hardware components of the apparatus operating in a first configuration to operate in a second configuration, wherein the license payload includes an indicator of a history binding that binds the license payload to follow the first configuration; and determine the received license payload is valid for application of the second configuration to the apparatus based on the history binding.

In another example, an apparatus for payload processing is provided. The apparatus includes: means for receiving a license payload for configuring a plurality of hardware components of the apparatus operating in a first configuration to operate in a second configuration, wherein the license payload includes an indicator of a history binding that binds the license payload to follow the first configuration; and means for determining the received license payload is valid for application of the second configuration to the apparatus based on the history binding.

In some aspects, one or more the apparatuses or devices described herein is, is part of, and/or includes a wearable device, an extended reality (XR) device (e.g., a virtual reality (VR) device, an augmented reality (AR) device, or a mixed reality (MR) device, such as an XR head-mounted device (HMD) device or XR glasses), a wireless communication device such as a mobile device (e.g., a mobile telephone and/or mobile handset and/or so-called “smartphone” or another mobile device), a vehicle or a computing device or system of a vehicle, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers or gyroscopes, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1. is a block diagram of an example system on chip (SoC) in accordance with some aspects of the disclosure;

FIG. 2 is a conceptual diagram of an SoC and implementation of the SoC and variations of the SoC into different products in accordance with some aspects of the disclosure;

FIG. 3 is a conceptual illustration illustrating applying a license payload to an SoC to create a unique configuration in accordance with some aspects of the disclosure;

FIG. 4 is a conceptual illustration of applying license payloads to cause the SoC to have a faulty configuration in accordance with some aspects of the disclosure;

FIG. 5 is a conceptual illustration of a license validation system to prevent faulty configuration of an SoC in accordance with some aspects of the disclosure;

FIG. 6 is a conceptual illustration of different hardware components of an SoC and various configurations that are dependent on hardware configuration in accordance with some aspects of the disclosure;

FIG. 7 is a conceptual illustration of historical bindings of a license payload that are configured in a license validation system in accordance with some aspects of the disclosure;

FIG. 8 is a conceptual illustration of an active configuration of a license payload that constrain applications of license payloads in accordance with some aspects of the disclosure;

FIG. 9 is a flow diagram illustrating an example of a process for validating licenses that modify a hardware configuration of a device in accordance with some aspects of the disclosure;

FIG. 10 shows an example of a computing system, which may be for example any computing device that may implement components of the system.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

A System on Chip (SoC) integrates various components such as a central processor unit (CPU), a graphics processor unit (GPU), memory, and peripheral interfaces onto a single chip, offering a compact and efficient solution for powering devices like smartphones, tablets, and embedded systems. SoCs can come in different stock keeping units (SKUs), which represent variations in hardware configuration and changes to the SoC over time. These variations can be due to different hardware components, such as the integration of refinements in components (e.g., fixing hardware bugs), improvements in semiconductor processing (e.g., to improve yield rate), and other changes that can occur over time. The SoC can also be configured based on different features that cater to different market segments, such as by offering performance at different SKUs. For instance, a high-end SKU might offer maximum performance for flagship devices, while a lower-end SKU may be optimized for energy efficiency, targeting budget-friendly products. By providing multiple SKUs of the same SoC, manufacturers can address diverse user needs without developing entirely new chip designs.

When an entity licenses (e.g., obtains legal permission) an SoC from an original developer, a license grants the licensee (e.g., a device manufacturer) the right to integrate the SoC into the licensee's products with a degree of flexibility. For example, the licensee may have the ability to modify certain aspects of the SoC, such as customizing specific cores, optimizing power consumption, or enhancing performance to suit the licensee's product requirements. The licensee may, based on their license, generate a license payload that can be consumed (e.g., processed) by SoC or components of the system (e.g., a root of trust (RoT)) to reconfigure various aspects of the SoC in accordance with parameters and details within the license payload. These changes allow the licensee to differentiate products in the market while leveraging the core technology of the SoC.

An SoC may need to modify or change hardware operation after the initial release for several reasons. As technology evolves, the original licensor may introduce updates, new features, or optimizations to the SoC that require a modified license payload to activate or modify hardware behavior. In some cases, additional hardware may be unlocked to assist reduce potential hardware or software attacks. Market demand, regulatory compliance, or competitive pressures may also drive the need for revised hardware functionality, such as if the product's primary use case shifts significantly.

While there are constraints placed on a licensee's ability to modify a license payload, there are no constraints for the licensee to choose which specific license payloads (out of all license payloads that are issued to it) can applied to any given device and in which order. Consequently, this creates a combinatorial explosion in the number of device configurations that are necessary to test or qualify before deployment by a licensee or qualify on-device. Each configuration of the device can consume a significant amount of time to validate performance and as the number of potential configurations increases, the time to validate the license payload becomes impractical. Consequently, license payloads may not be fully validated and the license payload may configure the hardware devices in a faulty state since there is no guaranteed order of applying the license payloads. As an example, a modification to a GPU to limit the clock speed, but a subsequent modification to increase default output screen resolution may place the hardware in a faulty hardware state whereby the hardware is misconfigured to support its desired state.

Systems, apparatuses, processes (also referred to as methods), and computer-readable media (collectively referred to as “systems and techniques”) are described herein for generation and validation system for hardware configurations. For example, an apparatus is configured to receive a license payload for configuring a device operating in a first configuration to operate in a second configuration. For example, the device may be an SoC having a plurality of configurable hardware components. The license may include a history binding that binds the license payload to one of the existing configurations. A license payload should be applied (e.g. not rejected) by the device if the configuration of the license payload is identified by the binding value. In some cases, the apparatus may determine that the received license payload is valid for the application of the second configuration to the device based on the history binding. The history binding binds a specific hardware device, such as a particular SKU of in an SoC family to particular license payloads and ensures the correct license payload is applied to the correct device based on unique information. In one aspect, each license payload and each configuration is associated with a unique identifier. Restricting the application of license payloads based on the identification of the device configurations constrains the number of test cases needed to qualify or validate the license payload.

In some aspects, the systems and techniques also include an active configuration that binds a license payload to a specific order of license payloads. The active configuration ensures a correct order of license payloads is followed and ensures that a device is placed into a known state. The active configuration reduces the number of test cases from growing exponentially in the number of issued license payloads to a linear relationship and simplifies any validation prior to release or on-device testing and validation of a license payload of a customer device.

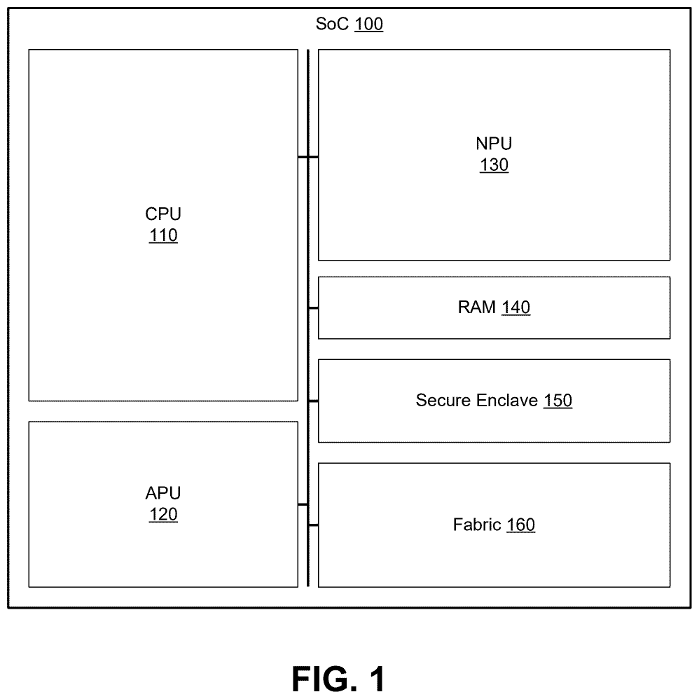

FIG. 1. is a block diagram of an example SoC 100 in accordance with some aspects of the disclosure. In some aspects, an SoC 100 is a semiconductor device that is manufactured and configured to include various components to integrate functions within the SoC to reduce delays associated with external interfaces and other impediments. For example, high-bandwidth video functions such as augmented and virtual reality may exceed the bandwidth of a DDR bus.

In one aspect, the SoC 100 may include at least one CPU 110 configured to execute software instructions. In some aspects, the CPU 110 comprises a plurality of processing cores that may be configured to execute the functionality in parallel, and the processing cores may have different configurations. For example, the CPU 110 may include a plurality of performance cores for low-latency functions and a plurality of efficiency cores that consume less power than the performance cores.

The SoC 100 may also include one or more accelerated processing units (APU) 120 that are configured to perform specific functions, such as floating point math. Non-limiting examples of APU functions include a GPU for video or mathematical operations, a neural network processing unit (NNPU) for performing neural network and vector-based operations, and so forth. For example, an NNPU, which may also be referred to as a neural engine, includes a plurality of neural processing cores for vector and matrix operations. A neural processing core includes arrays of multiply-accumulate (MAC) units and executes specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an machine learning model) or training of deep learning models. For example, the neural engine may perform computer vision tasks such as object recognition.

In some aspects, the SoC 100 may also include programmable logic devices such as a network processing unit (NPU) 130. The NPU 130 may be programmable using the programming protocol-independent packet processors (P4) language, which is a domain-specific programming language for network devices for processing packets. In some aspects, the NPU 130 may have a distributed P4 NPU architecture that may execute at line rate for small packets with complex processing, and may also include optimized and shared NPU fungible tables.

In some aspects, the SoC 100 may also include a volatile memory such as a random access memory (RAM) 140 that is shared between the various components (e.g., CPU 110, APU 120, NPU 130, etc.). As an example, a GPU (e.g., implemented in the APU 120) and the CPU 110 may share access to the RAM 140.

The SoC 100 may also include a secure enclave 150 such as a device root of trust (RoT) that is configured to secure the SoC 100 and identify any malicious issues. The secure enclave may include encryption generation functionality, a true random number generator, a secure storage medium, and so forth. In one aspect, the secure enclave 150 may securely store biometric information to enable various functions such as biometric authentication, etc.

The SoC 100 also includes a fabric 160 that is configured to facilitate interfacing the components of the SoC 100 internally and externally. As an example, the fabric 160 may include functionality to allocate the RAM 140 between the various shared components within the SoC 100. The SoC 100 may interconnect the various components using a bus to enable access to the various components, such as enabling the CPU 110 to address a portion of the RAM 140. In some aspects, the fabric 160 may also interface with external components such as a security sub-system, various bus interfaces (e.g., Peripheral Component Interconnect Express (PCI-e), thunderbolt, universal serial bus, a communication circuit for wireless communication, and so forth).

The SoC 100 may also include one or more accelerated processing units that are configured to perform specific functions. For example, the SoC 140 may include digital signal processors (DSPs), motion sensing co-processors, image signal processors (ISP), video encoders and decoders, network co-processors, wireless communication modules, audio encoders and decoders, cryptographic processors, and so forth.

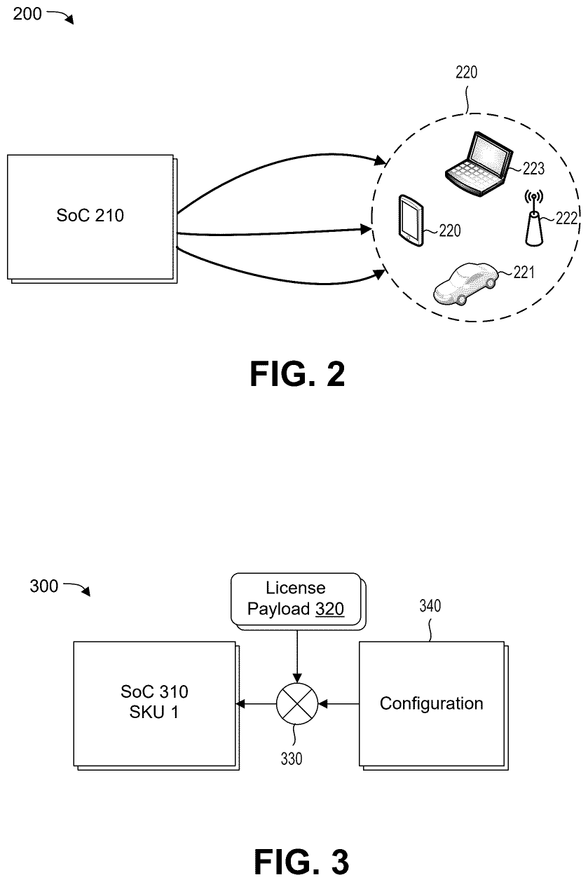

FIG. 2 is a conceptual diagram 200 of an SoC 210 and implementation of the different SKUs of the SoC 210 into different products in accordance with some aspects of the disclosure.

In some aspects, the development process of an SoC 210 includes many different stages from the design phase into production and ultimately turned into a product. The tape-out is the final stage of the design and layout of the semiconductor device and requires extensive processing such as layout verification, design rule checks, and timing analysis. The tape-out process is time consuming and requires significant effort, and circuit designers limit the scope of development by having a single design that can be adapted using a single design. Integrated circuits vary during the semiconductor processes (e.g., process corners) and performance of the semiconductor device may be binned into different performance tiers (e.g., high voltage, high frequency, low voltage, low frequency) to create multiple SKUs of the SoC device on the same wafer to maximize yield and offer a range of products suited for diverse needs, such as consumer electronics, industrial applications, or automotive use.

For example, a single wafer that includes the SoC 210 can be integrated into a variety of devices 220. For example, an SoC 210 from the wafer with high frequency performance can be integrated into a cellular phone 221, an SoC 210 with high voltage and thermal performance can be integrated into a vehicle 222, an SoC with a damaged graphics unit can be integrated into a device without an integrated display such as a router 223, and an SoC with low voltage performance can be integrated into an embedded device such as a digital watch 224 with touchscreen features (e.g., a smartwatch).

In this case, each SoC in the different product (e.g., the cellular phone 221, the vehicle 222, the router 223, and the digital watch 224) may have different performance profiles and features. For example, the router 223 does not require a graphics processor (e.g., a GPU). An electronics manufacturing company (e.g., a television manufacturing company that acquires display panels and processors, a phone manufacturing company, a laptop manufacturing company, an automotive manufacturing company, etc.) may acquire a license payload to further modify the behavior of the SoC to refine various features that are important to that electronics manufacturing company to differentiate its features over other competitors. For example, a phone manufacturing company may prioritize AI-based features and may configure the SoC for improved performance of machine-learning models at inference time.

FIG. 3 is a conceptual illustration of a license system for applying a license payload to create a unique configuration of an SoC in accordance with some aspects of the disclosure. In some aspects, the license system 300 illustrated in FIG. 3 includes at least one SoC 310 associated with a plurality of SKUs. A license 320 can be bound to the SoC 310 with a license application system 330. In some cases, the license application system 330 is an on-device operation and allows deployment to client devices using online processes and offline processes. An online process maintains a connection to the issuer of the license payload 320, and an offline process does not maintain a connection to the issuer of the license payload 320. For example, an online process may be an over-the-air (OTA) update process, and an offline process may be a configured via the application of the license payload 320 through another device (e.g., a laptop connected via a communication interface such as universal serial bus (USB), a file download from a network, an email attachment, and so forth).

As shown in FIG. 3, the arrows represent a dependency to create each unique configuration 340 of the SoC. For example, the SoC 310 is an initial configuration that is made available to a device manufacturer that includes default settings associated with the SKU. Different SKUs may have different settings, such as a frequency associated with a CPU bus, a number of performance CPU cores, a number of efficiency CPU cores, a bus frequency associated with memory, identification of GPU cores enabled, and so forth. Each device manufacturer can further customize the license payload based on the licensee's requirements. For example, a device manufacturer can support different output resolutions, different refresh rates, and so forth that comport with the device that the SoC 210 will be integrated into.

In one aspect, the license application system 330 can be an integrated into a RoT or other security subsystem such as a trusted execution environment (TEE) and is configured to apply the license payload 320 based on local validation of the license payload 320. In this way, the local device can prevent a license payload 320 having an incorrect hardware setting from applying the license payload 320 to cause the local device to have a faulty configuration.

In another aspect, the license application system 330 may be configured to generate and write firmware into the SoC 310 that controls low-level aspects of the SoC 310. For example, the license application system 330 can be an application that is executed at design time to generate a firmware, which is then written into each SoC 310 during design, test, and manufacturing cycles.

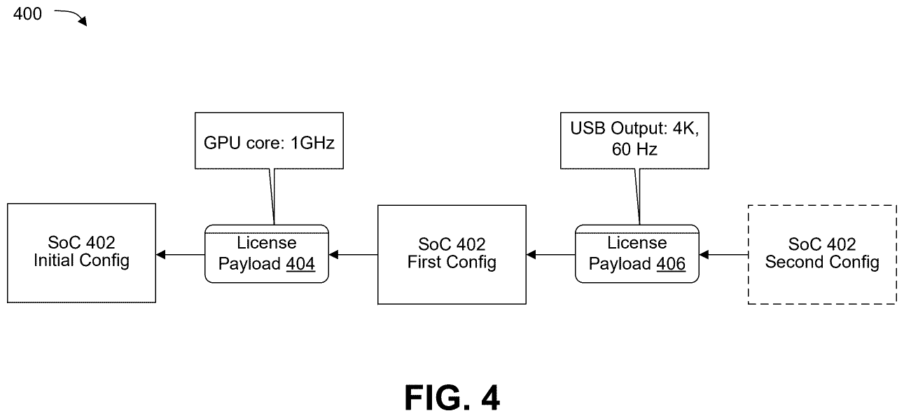

FIG. 4 is a conceptual illustration of applying license payloads to cause the SoC to have a faulty configuration in accordance with some aspects of the disclosure. In the following example, the process can be performed during design or after deployment to customers. In some aspects, an SoC 402 with an initial configuration is provided, and a first license payload 404 is applied to modify a setting to change a GPU core clock speed to 1 GHz, which generates a first configuration of the SoC 402. A change can be propagated by the first license payload 404 with different mechanisms. For example, the first license payload 404 can apply a differential update that only updates the SoC 402 based on identified properties in the first license 4 payload 04 to update. In other cases, the first license payload 404 can apply a cumulative update that updates all settings in the SoC 402 based on information in the first license payload 404. In addition, there are other complexities with cumulative updates such as omitted data in the first license payload 404. For example, if the first license payload 404 omits a particular setting and a corresponding value, a setting or other remediation can be used to determine if the setting and value are unaltered or removed.

In some aspects, license payloads can cause the SoC 402 to be placed into a faulty configuration, particularly if there are no constraints on how the license payload is applied. Licensees are generally free to apply license payloads in any order. For example, a second license payload 406 is applied to the first configuration of the SoC 402 to place the SoC 402 into a second configuration. The second license payload 406 enables a default USB output mode of a resolution of 4K (e.g., 3840×2160) with a refresh rate of 60 Hz. In this case, because the first license payload 404 limited the GPU core speed, applying the second license payload 406 increases the video processing requirements and may misconfigure the second configuration of the SoC 402 to have insufficient resources to output a video signal.

The second configuration of the SoC 402 is a faulty configuration that makes the SoC 402 inoperable. In this case, the second license payload 406 changes a property of the SoC 402 while the parent hardware component (e.g., the GPU) is configured in a state that cannot support the new property. In some aspects, the faulty configuration can be identified in testing based on every feasible combination of property and values. In practice, the number of test cases is exponentially related to the number of hardware components and their corresponding values and makes testing for every possible hardware configuration impractical. For example, validating the performance of an SoC configured by a license payload change may take several minutes, which limits the validation of the configurations to a minuscule fraction of all possible combinations based on time constraints.

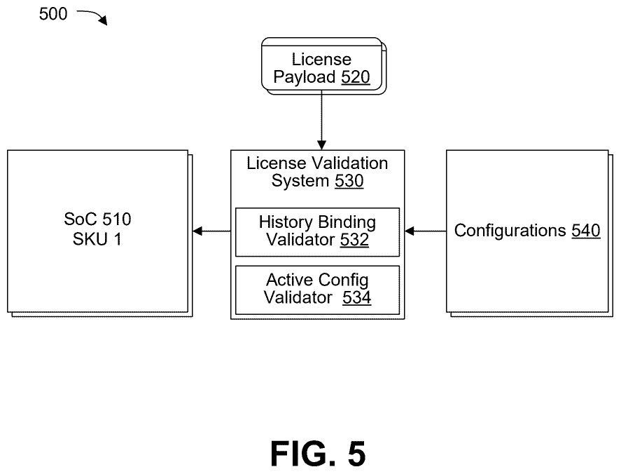

FIG. 5 is a conceptual illustration of a license validation system to prevent faulty configuration of an SoC in accordance with some aspects of the disclosure. In some aspects, an SoC 510 can be configured to receive a license payload 520 from a license validation system 530 to be associated with one or more configurations 540.

In some aspects, the license validation system 530 includes history binding validator 532 that is configured to validate a history binding of a next license payload with respect to a previous license payload. A history binding uniquely identifies a combination of features in a license payload 520 and is mapped to a previous configuration. For example, the history binding can be a unique identifier (e.g., a universally unique identifier (UUID)). In some aspects, a history binding also identifies a relationship between a previous configuration with respect to the next configuration. The previous configuration can be any prior configuration and may be related to different types of changes to apply. For example, the license payload 520 may apply logic to generate the configurations 540 based on the history binding to ensure that the SoC is 510 maintained in a valid configuration. The previous configuration can be an initial configuration or can be an intermediate configuration that is based on initial configuration.

The history binding prevents application of a license payload to a device (e.g., an SKU) to which the license payload was not intended based on a relationship between prior license payloads and the next license payload and can prevent the misconfiguration of the hardware settings. For example, the history binding validator 532 may validate the history binding in the next license payload so that each license payload can be used only following one specific device configuration. For example, the history binding may identify an initial configuration. However, the history binding may also identify a subsequent configuration based on a license payload. For example, a unique identifier can be generated for each unique configuration of the device configuration and may be selected based on the license payload that produced the configuration. In some aspects, the history binding validator 532 ensures that the application of the next license payload requires a specific prerequisite configuration. The prerequisite configuration can be a prior configuration and is not necessarily the current configuration.

For example, when the license validation system 530 is applied to an initial configuration, a history binding of the license validation system 530 contains an identifier associated with the initial configuration. In another example, when the license validation system 530 follows another license payload, the license validation system 530 contains the unique identifier of the previous license payload. Ensuring the uniqueness of the history binding can be accomplished by issuing unique identifiers for each of the initial configurations and each of the license payloads. In this respect, the history binding allows the binding of appropriate license payloads to a specific SKU associated with the SoC 510.

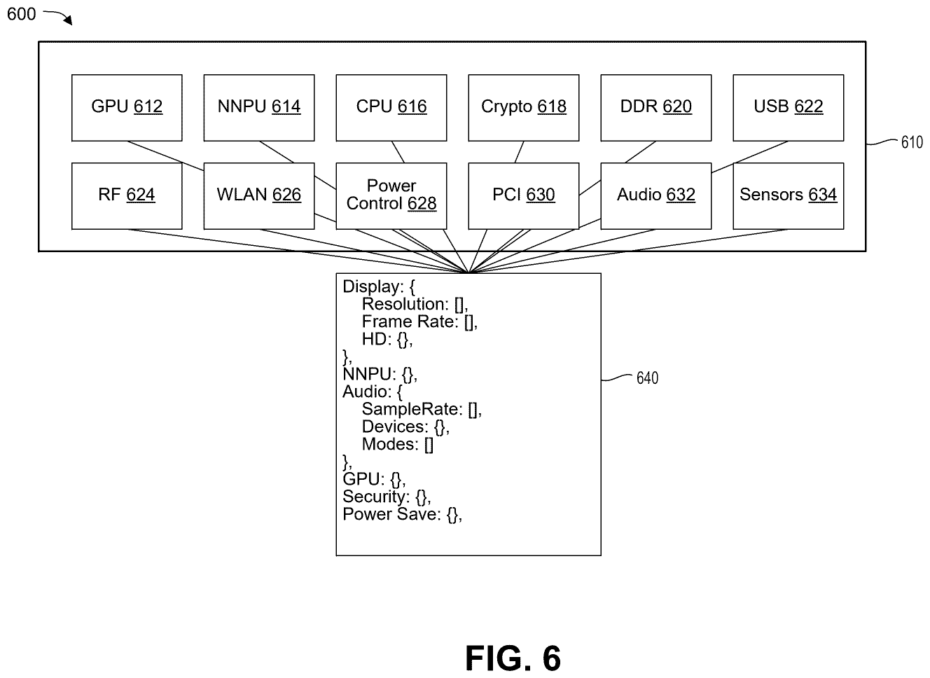

FIG. 6 is a conceptual illustration of different hardware components of an SoC 600 and various configurations that are dependent on hardware configuration in accordance with some aspects of the disclosure.

In one example, an SoC can include a plurality of configurable hardware components 610, such as GPU 612, NNPU 614, CPU 616, cryptographic devices 618 (e.g., a random number generator), memory 620, USB 622, radio frequency (RF) devices 624, wireless local area network (WLAN) devices 626, power control devices 628, peripheral component interconnect (PCI) 630, audio devices 632, and sensors 634. The SoC 600 is an example of the number of different components as many other components can be included such as radio frequency identifier (RFID), ultrawideband (UWB), and so forth.

An example configuration 640 is illustrated that identifies features that are dependent on one or more configurable hardware components 610. For example, the configuration 640 includes a display property, which is dependent on at least the GPU 612, but may also depend on additional hardware components such as USB 622. The SoC 600 may also include a discrete video output component that outputs video signals (e.g., high-definition multimedia interface (HDMI), etc.) that is omitted for purposes of simplicity. In some cases, a licensee can alter various aspects of the configuration 640 but fail to address every possible parent hardware setting. For example, hardware-based changes to the WLAN 626 functionality may be related to the RF devices 624, the WLAN devices 626, and the power control devices 628.

The configuration 640 can include many different settings related to supported components, authentication of various aspects of the device, and various features enabled by the SoC 600. The configuration 640 in this case illustrates a fraction of various properties that are necessary for an integrated device including the SoC 600 to operate seamlessly.

In some aspects, the history binding ensures that the configuration 640 is constrained based on a previous relationship to a prior license payload and ensures that a faulty configuration cannot be entered based on maintaining the relationships with other prior license payloads. In addition, the history binding and the configuration 640 can be used to develop logic and functionality to accurately propagate the changes listed in the configuration 640 based on the prior license payload.

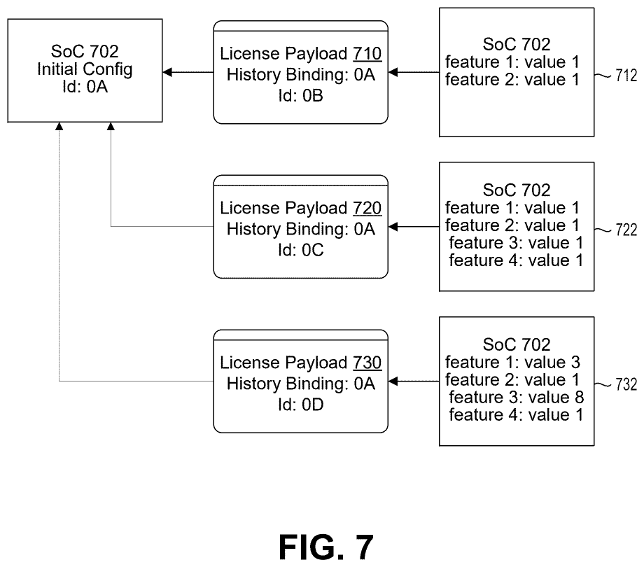

FIG. 7 is a conceptual illustration of historical bindings of a license payload that are configured in a license validation system in accordance with some aspects of the disclosure. In this case, an SoC 702 has an initial configuration with an identifier of 0A, and the initial configuration has a unique identifier (e.g., a UUID).

In some aspects, a license payload 710 can be applied to the SoC 702 to generate a first configuration 712. In the first configuration 712, the SoC 702 enables feature 1 with a value of 1. As an example, feature 1 can be a performance CPU core speed and the value 1 is an enumerator corresponding to a speed of 2 GHz. The first configuration 712 enables feature 2,which is a number of enabled GPU cores, with a value of 1, which is an enumerator that enables two GPU cores. In this case, the license payload 710 may have a history binding that includes a unique identifier associated with the initial configuration (0A) and also includes an identifier (0B) associated with the first configuration 712.

A second license payload 720 can be applied to the SoC 702 to generate a second configuration 722. The second license payload 720 has a history binding to the initial configuration (0A) and includes an identifier (0C) of the second configuration 722. In this case, the second license payload 720 enables feature 3 and feature 4.

A third license payload 730 can be applied to the SoC 702 to generate a third configuration 732. The third license payload 730 has a history binding to the initial configuration (0A) and includes an identifier (0D) of the third configuration 732. In this case, the third license payload 730 modifies the values of feature 1 and feature 3.

In this case, the history binding constrains the number of license payloads and the number of variations, thereby reducing the number of possible test cases based on the number of feature variations identified in the license payloads. The number of possible test cases may remain exponentially related but significantly reduces the total number of potential test or qualification cases.

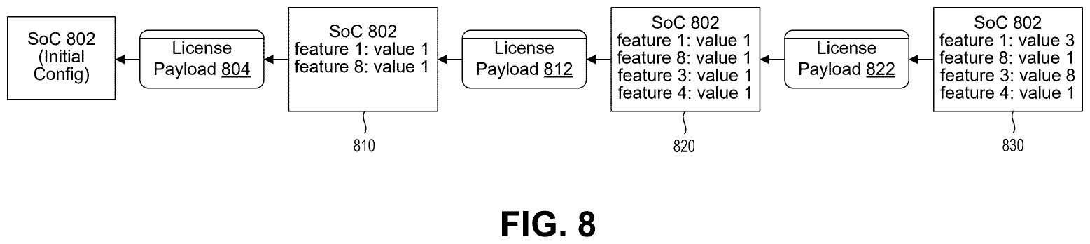

FIG. 8 is a conceptual illustration of an active configuration of a license payload that constrains applications of license payloads in accordance with some aspects of the disclosure. In some aspects, an active configuration is the latest application of a license payload and its enabled features, and license payloads may only be bound based on a relationship to the active configuration.

FIG. 8 illustrates an initial configuration of an SoC 802 is the active configuration when no further license payload has been applied. When a first license payload 804 is bound to the initial configuration, the SoC 802 is associated with a first active configuration 810. In some aspects, when a second license payload 812 is applied to the first active configuration 810, the SoC 802 has a second active configuration 820. A second license payload 822 can then be bound to the second active configuration 820 to cause the SoC 802 to have a third active configuration 830.

In this case, the active configuration identifies an order in which the license payloads can be applied and constrains the order in which license payloads can be applied. For example, the first license payload 804, the second license payload 812, and the second license payload 822 can all be applied to the initial configuration. However, the first license payload 804 cannot be bound to the second active configuration 820 or the third active configuration 830.

The active configuration enables the binding of license payloads to further constrain the number of test or qualification cases of an SoC 802, which reduces the qualification of a license payload to a linear relationship to the number of license payloads. For example, the number of qualification cases of three license payloads in three, subject to potential other test cases that are not related to license payload (e.g., a memory validation test, etc.). In some cases, once the license payload is configured on-device, the device can validate functionality based on an embedded testing function to prevent a configuration that permanently damages the device and makes it inoperable.

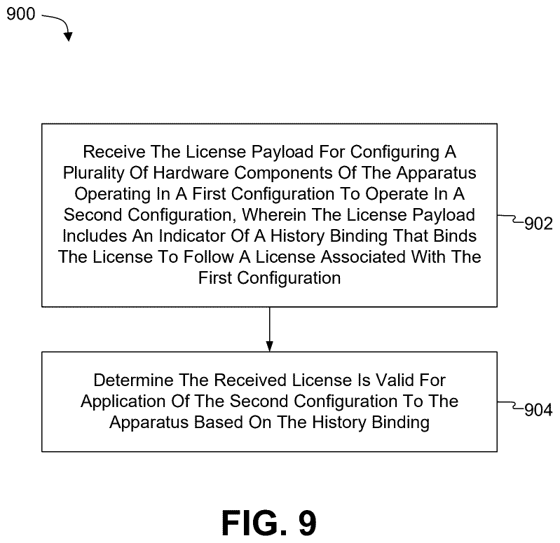

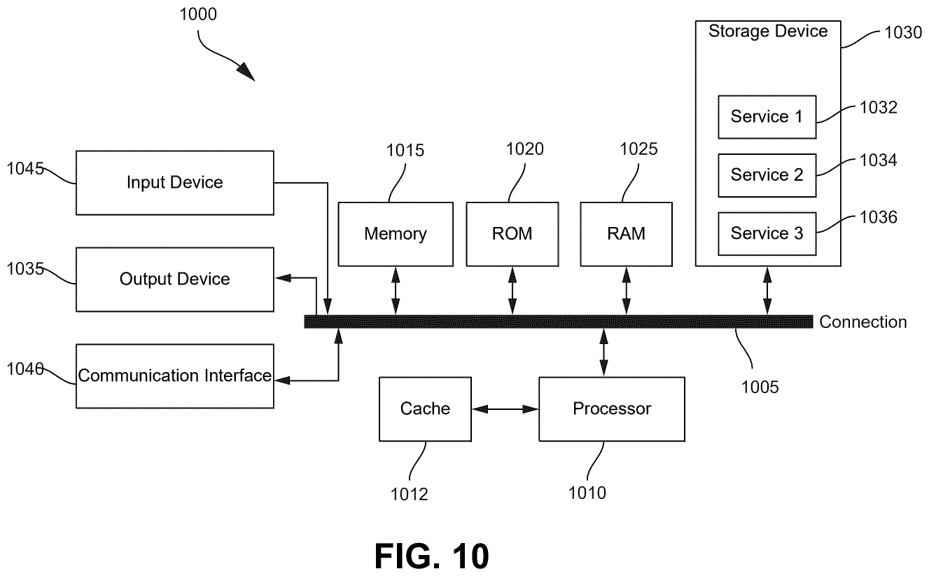

FIG. 9 is a flowchart illustrating an example process 900 for payload processing (e.g., validating license payloads that modify a hardware configuration of a device), in accordance with aspects of the present disclosure. The process 400 can be performed by a computing device (or apparatus) or a component (e.g., one or more chipsets, a SoC, one or more processors such as one or more CPUs, GPUs, DSPs, NPUs, NNPUs, neural signal processors (NSPs), microcontrollers, application specific integrated circuits (ASICs), functional programmable gate arrays (FPGAs), programmable logic devices, discrete gates or transistor logic components, discrete hardware components, etc., a machine learning system such as a neural network model, any combination thereof, and/or other component or system) of the computing device. The operations of the process 900 may be implemented as software components that are executed and run on one or more processors (e.g., CPU, GPU, DSP, NPU or neural engine, SoC, the processor 1010 of FIG. 10, and/or other processor(s)).

At block 902, the computing device (or component thereof) may receive the license payload for configuring a plurality of hardware components of the apparatus operating in a first configuration to operate in a second configuration. In some aspects, the computing device may be an apparatus including a configurable SoC using license payloads. The computing device may also be a configurable SoC. When the license payload is received, the computing device may be configured with the first configuration based on a prior license payload or an initial configuration. For example, the first configuration can be an initial configuration (e.g. not configured with a license payload) or an updated configuration (e.g., configured with a previous license payload).

The second configuration configures at least one hardware component of the plurality of hardware components of the apparatus to operate differently as compared to operation of the at least one hardware component in the first configuration. For example, the second configuration can change enabled processor cores, change hardware operation such as bus frequency, voltages, memory timings, etc. As an example, the license payload includes an identity of at least one hardware component of the apparatus and a value associated of operation of the at least one hardware component.

In some aspects, each license payload is associated with a unique configuration of the plurality of hardware components of the apparatus and values associated with operation of the plurality of hardware components.

At block 904, the computing device (or component thereof) may determine the received license payload is valid for application of the second configuration to the apparatus based on the history binding. In some aspects, the history binding precludes the computing device from entering an invalid state and/or an untested state. The computing device may, in response to determining the received license payload is valid for application, apply the received license payload to the computing device.

In some cases, the license payload may include an indicator of a history binding that binds the license payload to follow the first configuration. The indicator of the history binding includes a unique identifier associated with the first configuration. In one aspect, to validate the second configuration, the computing device may determine that the unique identifier associated with the first configuration is included in the license payload. In another aspect, to validate the second configuration, the computing device may determine that the apparatus is configured with the first configuration, and the apparatus in the first configuration validates the second configuration. In this case, the first configuration is different from a previous configuration and constrains an order of license payloads applied to the computing device.

In some aspects, the computing device may perform one or more tests on the computing device to validate performance of the computing device based on the second configuration. In this case, the number of qualification cases of each test per SKU of the apparatus for testing the license payload prior to distribution is linearly related to a number of prior license payloads.

In some cases, the computing device can be integrated into a manufacturer's processes. For example, a license issuer may choose to issue a license payload to a licensee if the configuration, resulting from the application of the previous license payload has been successfully validated or qualified.

In some aspects, the computing device may identify a first policy of a plurality of policies. Each policy in the plurality of policies identifies application of the history binding to the first configuration. For example, different policies can be applied to different SKUs based on different configurations, different process corners, and other variations. The different policies can also be used to identify how the changes are made to the hardware components (e.g., differential updates, cumulative updates, etc.).

FIG. 10 is a diagram illustrating an example of a system for implementing certain aspects of the present technology. In particular, FIG. 10 illustrates an example of a computing system 1000, which can be for example any computing device making up internal computing system, a remote computing system, a camera, or any component thereof in which the components of the system are in communication with each other using a connection 1005. The connection 1005 can be a physical connection using a bus, or a direct connection into the processor 1010, such as in a chipset architecture. The connection 1005 can also be a virtual connection, networked connection, or logical connection.

In some aspects, the computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

An example computing system 1000 includes at least one processing unit (a central processing unit (CPU) or processor) 1010 and a connection 1005 that couples various system components including a system memory 1015, such as ROM 1020 and RAM 1025 to the processor 1010. The computing system 1000 can include a cache 1012 of high-speed memory connected directly with, in close proximity to, or integrated as part of the processor 1010.

The processor 1010 can include any general purpose processor and a hardware service or software service, such as services 1032, 1034, and 1036 stored in the storage device 1030, configured to control the processor 1010 as well as a special-purpose processor where software instructions are incorporated into the actual processor design. The processor 1010 may essentially be a completely self-contained computing system, containing multiple cores or processors, a bus, memory controller, cache, etc. A multi-core processor may be symmetric or asymmetric.

To enable user interaction, the computing system 1000 includes an input device 1045, which can represent any number of input mechanisms, such as a microphone for speech, a touch-sensitive screen for gesture or graphical input, keyboard, mouse, motion input, speech, etc. The computing system 1000 can also include an output device 1035, which can be one or more of a number of output mechanisms. In some instances, multimodal systems can enable a user to provide multiple types of input/output to communicate with the computing system 1000. The computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as the processor 1010, the connection 1005, the output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 900, and/or other process described herein) may be performed by a computing device or apparatus. In one example, the method 900 can be performed by a computing device having a computing architecture of the computing system 1000 shown in FIG. 10.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure include:

Aspect 1. An apparatus for payload processing, the apparatus comprising: at least one memory configured to store a license payload; and at least one processor coupled to the at least one memory and configured to: receive a license payload for configuring a plurality of hardware components of the apparatus operating in a first configuration to operate in a second configuration, wherein the license payload includes an indicator of a history binding that binds the license payload to follow the first configuration; and determine the received license payload is valid for application of the second configuration to the apparatus based on the history binding.

Aspect 2. The apparatus of Aspect 1, wherein the second configuration configures at least one hardware component of the plurality of hardware components of the apparatus to operate differently as compared to operation of the at least one hardware component in the first configuration.

Aspect 3. The apparatus of any of Aspects 1 to 2, wherein each license payload is associated with a unique configuration of the plurality of hardware components of the apparatus and values associated with operation of the plurality of hardware components.

Aspect 4. The apparatus of any of Aspects 1 to 3, wherein the license payload includes an identity of at least one hardware component of the apparatus and a value associated of operation of the at least one hardware component.

Aspect 5. The apparatus of any of Aspects 1 to 4, wherein the indicator of the history binding includes a unique identifier associated with the first configuration, and wherein, to validate the second configuration, the at least one processor is configured to: determine that the unique identifier associated with the first configuration is included in the license payload.

Aspect 6. The apparatus of any of Aspects 1 to 5, wherein, when the license payload is received, the at least one processor is configured with the first configuration based on a prior license payload or an initial configuration.

Aspect 7. The apparatus of any of Aspects 1 to 6, wherein, to validate the second configuration, the at least one processor is configured to: determine that the apparatus is configured with the first configuration, wherein the apparatus in the first configuration validates the second configuration.

Aspect 8. The apparatus of any of Aspects 1 to 7, wherein the first configuration is different from a previous configuration and constrains an order of license payloads applied to the apparatus.

Aspect 9. The apparatus of any of Aspects 1 to 8, wherein the at least one processor is configured to: perform one or more tests on the apparatus to validate performance of the apparatus based on the second configuration.

Aspect 10. The apparatus of Aspect 9, wherein a number of qualification cases of each test per stock keeping unit (SKU) of the apparatus for testing the license payload prior to distribution is linearly related to a number of prior license payloads.

Aspect 11. The apparatus of any of Aspects 1 to 10, wherein the history binding precludes the apparatus from entering an invalid state or an untested state.

Aspect 12. The apparatus of any of Aspects 1 to 11, wherein the apparatus is a system on chip (SoC).

Aspect 13. The apparatus of any of Aspects 1 to 12, wherein the license payload is issued by a license issuer based on validation of a previous license payload.

Aspect 14. The apparatus of any of Aspects 1 to 13, wherein the at least one processor is configured to: in response to determining the received license payload is valid for application, apply the received license payload to the apparatus.

Aspect 15. The apparatus of any of Aspects 1 to 14, wherein the at least one processor is configured to: identifying a first policy of a plurality of policies, wherein each policy in the plurality of policies identifies application of the history binding to the first configuration.

Aspect 16. A method for payload processing, comprising: receiving a license payload for configuring a plurality of hardware components of an apparatus operating in a first configuration to operate in a second configuration, wherein the license payload includes an indicator of a history binding that binds the license payload to follow the first configuration; and determining the received license payload is valid for application of the second configuration to the apparatus based on the history binding.

Aspect 17. The method of Aspect 16, wherein the second configuration configures at least one hardware component of the plurality of hardware components of the apparatus to operate differently as compared to operation of the at least one hardware component in the first configuration.

Aspect 18. The method of any of Aspects 16 to 17, wherein each license payload is associated with a unique configuration of the plurality of hardware components of the apparatus and values associated with operation of the plurality of hardware components.

Aspect 19. The method of any of Aspects 16 to 18, wherein the license payload includes an identity of at least one hardware component of the apparatus and a value associated of operation of the at least one hardware component.

Aspect 20. The method of any of Aspects 16 to 19, wherein the indicator of the history binding includes a unique identifier associated with the first configuration, and wherein validating the second configuration comprises determining that the unique identifier associated with the first configuration is included in the license payload.

Aspect 21. The method of any of Aspects 16 to 20, wherein, when the license payload is received, the apparatus is configured with the first configuration based on a prior license payload or an initial configuration.

Aspect 22. The method of any of Aspects 16 to 21, wherein validating the second configuration comprises determining that the apparatus is configured with the first configuration, wherein the apparatus in the first configuration validates the second configuration.

Aspect 23. The method of any of Aspects 16 to 22, wherein the first configuration is different from a previous configuration and constrains an order of license payloads applied to the apparatus.

Aspect 24. The method of any of Aspects 16 to 23, further comprising performing one or more tests on the apparatus to validate performance of the apparatus based on the second configuration.

Aspect 25. The method of Aspect 24, wherein a number of qualification cases of each test per stock keeping unit (SKU) of the apparatus for testing the license payload prior to distribution is linearly related to a number of prior license payloads.

Aspect 26. The method of any of Aspects 16 to 25, wherein the history binding precludes the apparatus from entering an invalid state or an untested state.

Aspect 27. The method of any of Aspects 16 to 26, wherein the apparatus is a system on chip (SoC).

Aspect 28. The method of any of Aspects 16 to 27, further comprising issuing the license payload to a licensee based on validation of the license payload.

Aspect 29. The method of any of Aspects 16 to 28, further comprising, in response to determining the received license payload is valid for application, applying the received license payload to the apparatus.

Aspect 30. The method of any of Aspects 16 to 29, further comprising identifying a first policy of a plurality of policies, wherein each policy in the plurality of policies identifies application of the history binding to the first configuration.

Aspect 31. A non-transitory computer-readable medium having stored thereon instructions that, when executed by at least one processor, cause the at least one processor to perform operations according to any of Aspects 16 to 30.

Aspect 32. An apparatus for configuring an apparatus based on a license payload, comprising one or more means for performing operations according to any of Aspects 16 to 30.

What is claimed is:

1. An apparatus for payload processing, the apparatus comprising:
at least one memory; and
at least one processor coupled to the at least one memory and configured to:
receive a license payload for configuring a plurality of hardware components of the apparatus operating in a first configuration to operate in a second configuration, wherein the license payload includes an indicator of a history binding that binds the license payload to follow the first configuration; and
determine the received license payload is valid for application of the second configuration to the apparatus based on the history binding.

2. The apparatus of claim 1, wherein the second configuration configures at least one hardware component of the plurality of hardware components of the apparatus to operate differently as compared to operation of the at least one hardware component in the first configuration.

3. The apparatus of claim 1, wherein each license payload is associated with a unique configuration of the plurality of hardware components of the apparatus and values associated with operation of the plurality of hardware components.

4. The apparatus of claim 1, wherein the license payload includes an identity of at least one hardware component of the apparatus and a value associated of operation of the at least one hardware component.

5. The apparatus of claim 1, wherein the indicator of the history binding includes a unique identifier associated with the first configuration, and wherein, to validate the second configuration, the at least one processor is configured to:
determine that the unique identifier associated with the first configuration is included in the license payload.

6. The apparatus of claim 1, wherein, when the license payload is received, the at least one processor is configured with the first configuration based on a prior license payload or an initial configuration.

7. The apparatus of claim 1, wherein, to validate the second configuration, the at least one processor is configured to:
determine that the apparatus is configured with the first configuration, wherein the apparatus in the first configuration validates the second configuration.

8. The apparatus of claim 1, wherein the first configuration is different from a previous configuration and constrains an order of license payloads applied to the apparatus.

9. The apparatus of claim 1, wherein the at least one processor is configured to:
perform one or more tests on the apparatus to validate performance of the apparatus based on the second configuration.

10. The apparatus of claim 9, wherein a number of qualification cases of each test per stock keeping unit (SKU) of the apparatus for testing the license payload prior to distribution is linearly related to a number of prior license payloads.

11. The apparatus of claim 1, wherein the history binding precludes the apparatus from entering an invalid state or an untested state.

12. The apparatus of claim 1, wherein the apparatus is a system on chip (SoC).

13. The apparatus of claim 1, wherein the license payload is issued by a license issuer based on validation of a previous license payload.

14. The apparatus of claim 1, wherein the at least one processor is configured to:
in response to determining the received license payload is valid for application, apply the received license payload to the apparatus.

15. The apparatus of claim 1, wherein the at least one processor is configured to:
identifying a first policy of a plurality of policies, wherein each policy in the plurality of policies identifies application of the history binding to the first configuration.

16. A method for payload processing, the method comprising:
receiving a license payload for configuring a plurality of hardware components of an apparatus operating in a first configuration to operate in a second configuration, wherein the license payload includes an indicator of a history binding that binds the license payload to follow the first configuration; and
determining the received license payload is valid for application of the second configuration to the apparatus based on the history binding.

17. The method of claim 16, wherein the second configuration configures at least one hardware component of the plurality of hardware components of the apparatus to operate differently as compared to operation of the at least one hardware component in the first configuration.

18. The method of claim 16, wherein each license payload is associated with a unique configuration of the plurality of hardware components of the apparatus and values associated with operation of the plurality of hardware components.

19. The method of claim 16, wherein the license payload includes an identity of at least one hardware component of the apparatus and a value associated of operation of the at least one hardware component.

20. The method of claim 16, wherein the indicator of the history binding includes a unique identifier associated with the first configuration, and wherein validating the second configuration comprises:
determining that the unique identifier associated with the first configuration is included in the license payload.
